(19) United States
(12) Patent Application Publication
(10) Pub. No.: US 2010/0325201 A1
(43) Pub. Date: Dec. 23, 2010

(54) System and Method for Remote Management of Dynamic Address Book Application

(75) Inventors: Suresh Chitturi, Plano, TX (US); Axel Ferrazzini, Brussels (BE)

Correspondence Address: Research in Motion Corp./CR;Attn: J. Robert Brown, 5601 Granite Parkway, Suite 750, Plano, TX, 75024, US

(73) Assignee: RESEARCH IN MOTION LIMITED, Waterloo (CA)

(21) Appl. No.: 12/817,069

(22) Filed: Jun. 16, 2010

Related U.S. Application Data
(60) Provisional application No. 61/218,902, filed on Jun. 19, 2009.

(51) Int. Cl. G06F 15/16; G06F 15/173

(52) U.S. Cl. 709/203; 709/223

(57) ABSTRACT

A computer readable storage medium storing a data structure comprising a converged address book (CAB) management object (MO). The CAB MO includes data that allows a CAB client to be configured to use a CAB service. The CAB MO further comprises at least one property selected from the group consisting of: CAB release information, service provider identification, a CAB server access address, XDMS properties, CAB address book synchronization type, an indication of the technology to be used to support management of CAB XML documents from the CAB client, a search schema universal resource indicator (URI), notification information, notification payload schema, and a CAB web access URI.

### CROSS-REFERENCE TO RELATED APPLICATIONS

The present application claims priority to U.S. provisional patent application No. 61/218,902 filed Jun. 19, 2009, by Suresh Chitturi, et al, entitled “System and Method for Remote Management of Dynamic Address Book Application” (35631-US-PRV-4214-18300), which is incorporated by reference herein as if reproduced in its entirety.

### BACKGROUND

As used herein, the terms “mobile station” (“MS”) and “user equipment” (“UE”) might in some cases refer to mobile devices such as mobile telephones, personal digital assistants, handheld or laptop computers, and similar devices that have telecommunications capabilities. Such a MS might consist of a MS and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. As used herein, the term “SIM” may also refer to “USIM” and the term “USIM” may also refer to “SIM.” Alternatively, such a MS might consist of the device itself without such a module. In other cases, the term “MS” might refer to devices that have similar capabilities but that are not transportable, such as desktop computers, set-top boxes, or network appliances. The term “MS” can also refer to any hardware or software component that can terminate a communication session for a user. Also, the terms “MS,” “UE,” “user agent” (“UA”), “user device” and “user node” might be used synonymously herein.

As telecommunications technology has evolved, more advanced network access equipment has been introduced that can provide services that were not possible previously. This network access equipment might include systems and devices that are improvements of the equivalent equipment in a traditional wireless telecommunications system. Such advanced or next generation equipment may be included in evolving wireless communications standards, such as long-term evolution (LTE) or LTE Advanced (LTE-A). For example, these systems might include an enhanced node B (eNB), a wireless access point, or a similar component rather than a traditional base station.

As used herein, the term “access node” will refer to any component of the wireless network, such as a traditional base station, a wireless access point, relay, or an eNB, that creates a geographical area of reception and transmission coverage allowing a MS to access to other components in a telecommunications system. In this document, the term “access node” may comprise a plurality of hardware and software. An access node, core network component, or other device, may provide wireless communications resources in an area known as a cell.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustrating converged address book (CAB) architecture and communication system, according to an embodiment of the disclosure.

FIG. 2 is a block diagram illustrating an exemplary CAB management object, according to an embodiment of the disclosure.

FIG. 3 is a flowchart illustrating a process of configuring a CAB client, according to an embodiment of the disclosure.

FIG. 4 is a flowchart illustrating a process of generation and transmission of a CAB DMO to the CAB client, according to an embodiment of the disclosure.

FIG. 5 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used herein, the following terms have the following definitions.

“AB” is defined as “Address Book.”

“Agent” is defined as software and/or hardware which uses a Management Object “MO” (see below) for configuration of the software and/or hardware's services.

“AUID” is defined as “Application Usage Identification.”

“CAB,” as set forth by the Open Mobile Alliance (OMA), is defined as “Converged Address Book,” which is a system, a service, and/or software for managing a user's address book functionality by way of a CAB Server (e.g., a network entity/component comprising at least one of server hardware and server software) and a CAB Client (e.g., a MS/UE entity component comprising at least one of client hardware and client software).

“DM,” as set forth by the Open Mobile Alliance (OMA), is defined as “Device Management,” which is a process of configuring and/or managing a device such as but not limited to a mobile station.

“DMO” is defined as “Device Management Object.”

“DS” is defined as “Data Synchronization.”

“IP” is defined as “Internet Protocol.”

“MMS” is defined as “Multimedia Messaging Service.”

“MO” is defined as “Management Object,” which is a data structure and data transferred among mobile stations.

“MS” is defined as “Mobile Station.”

“OMA” is defined as “Open Mobile Alliance,” which is an organization for promulgating standards in wireless communications.

“PCC” is defined as “Personal Contact Card.”

“P-CSCF” is defined as “Proxy Call Session Control Function.”

“SIP” is defined as “Session Initiated Protocol,” which is a communication protocol.

“SMS” is defined as “Short Message Service.”

“URI” is defined as “Universal Resource Indicator,” which in some embodiments may be a Universal Resource Locator (URL).

“WAP” is defined as “Wireless Application Protocol.”

“XCAP” is defined as “XML Configuration Access Protocol.”

“XDM” is defined as “XML Document Management,” which is an OMA specification for accessing and configuring XML documents stored in networked document repositories.

“XDMS” is defined as “XML Document Management Server,” which is a server or other computer for configuring, managing, and/or transmitting XML documents.

“XML” is defined as “eXtensible Markup Language,” which is a computer-readable language.

Other acronyms that may appear herein are used and defined according to the technical specifications of the Third Generation Partnership Project (3GPP) or OMA standards.

A service that might be offered to a user of an MS is a Converged Address Book (CAB). The CAB allows a user to maintain, on for example an MS or server, an address book for the use on a MS. The CAB provides flexibility and a number of advantages to the user, such as but not limited to data backup, updating of addresses by third parties, sharing of contact information, subscribing to changes in contact information of other users, importing non-CAB information, and searching for contact information.

However, no specific configuration parameters have been provided regarding management (e.g., remote management) of a CAB client. The embodiments described herein provide for device management object parameters that can be used to configure a CAB client to use a CAB service. More broadly, the embodiments described herein define CAB management objects and their parameters and/or data schemas in order to configure the CAB client to access and/or consume the CAB service.

Configuration of the CAB client using the parameters defined below may be accomplished remotely by an operator. The parameters may be pre-configured on or in association with the CAB client, or generated at a server and transmitted to the CAB client. Updates to the CAB client configuration may be performed using device management objects having the parameters described below. A combination of these techniques may also be used.

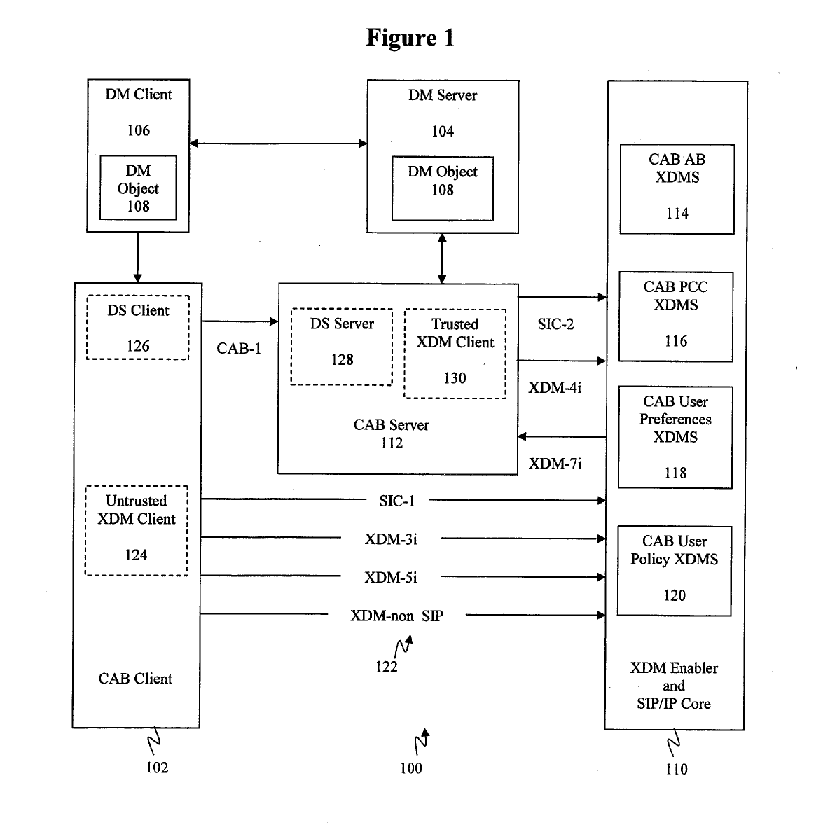

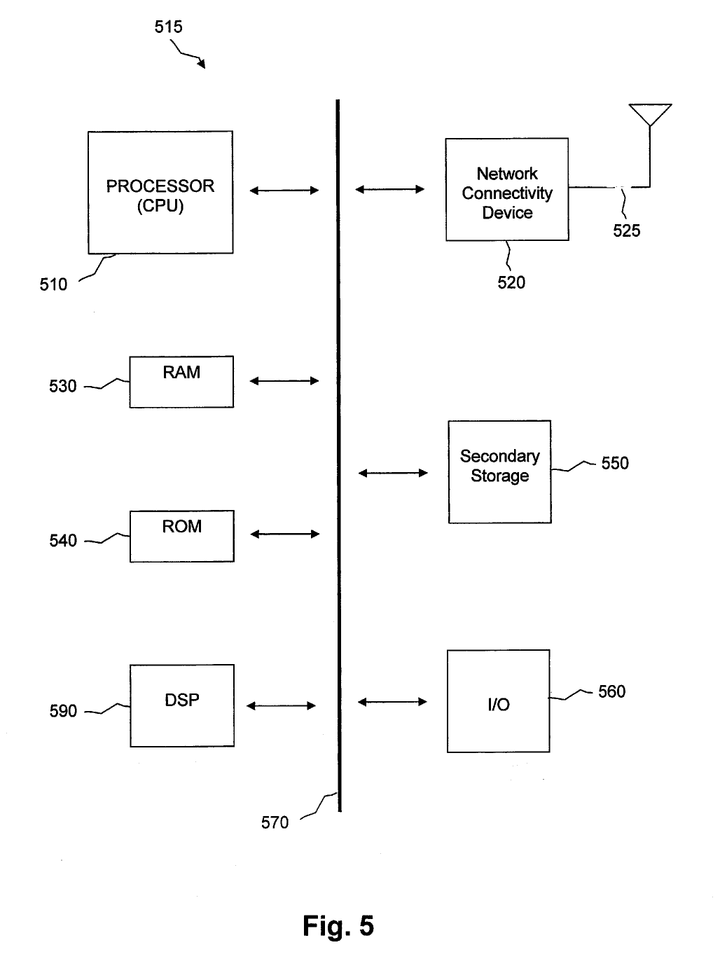

FIG. 1 is a block diagram illustrating converged address book (CAB) architecture and communication system, according to an embodiment of the disclosure. The various components shown in FIG. 1 may be implemented in one or more MSs, computers, and/or servers using one or more processors, such as those shown in FIG. 5. In an embodiment, the CAB architecture and communication system 100 may operate, at least in part, according to standards promulgated or specified by the OMA. In an embodiment, the CAB architecture and communication system 100 allows for the management of a remotely or locally stored and organized address book or address books for a user and/or CAB client 102. System 100 may be referred-to as a CAB enabler. The functionalities of the CAB enabler may include, but are not limited to, the features of backing up address book data in a network repository, sharing contact information, subscribing to changes in contact information of other users, importing of non-CAB address book information, and searching for available contact information from systems both internal and external to CAB. CAB client 102 may be provided on a MS or other device (e.g., an application server). The embodiments provide for management of CAB client 102 as well as for defining, configuring, and/or transmitting CAB MO parameters.

In an embodiment, OMA DM standards may be used for the remote management of components, such as CAB client 102 and DM client 106. For example, OMA DM defines the protocols that may be used for communication between a DM server 104 and a DM client 106. DM client 106 may be used by a CAB client 102, as described further below. DM client 106 may be hosted by CAB client 102, though in other embodiments a different device may host DM client 106.

Device management objects (DMOs), such as DMO 108, may be used to configure clients, such as CAB client 102. The DM server 104 may be used as an intermediary between CAB client 102 (hosting or using the DM Client) and CAB server 112. Likewise, CAB server 112 may be used as an intermediary between CAB client 102 and XDM enabler 110, or between XDM enabler 110 and DM server 104.

XDM Enabler 110, which may be part of an SIP/IP core, may be used as a network repository to implement a global standard for address book management. XDM Enabler 110 may include one or more XDMSs, such as CAB AB XDMS 114, CAB PCC XDMS 116, CAB User Preferences XDMS 118, and/or CAB User Policy XDMS 120. Other types of XDMS may be used in XDM enabler 110.

CAB client 102 may communicate directly with XDM enabler 110 using a number of different interface protocols, such as those shown at arrows 122, via Untrusted XDM client 124. Alternatively, CAB client 102 may communicate with XDM enabler 110 via CAB server 112, using protocols as shown. For example, a DS client 126 in CAB client 102 may communicate with DS server 128 in CAB server 112. Trusted XDM Client 130 in CAB server 112 may communicate with XDM enabler 110. In addition to the DS server 128 and the Trusted XDM Client 130, the CAB Server 112 may contain other intrinsic functions to address CAB functionality. Further, the CAB Server 112 may interact with the DM Server 104 via an interface either provided by the DM Server 104 or through an interface provided by the CAB Server 112 itself.

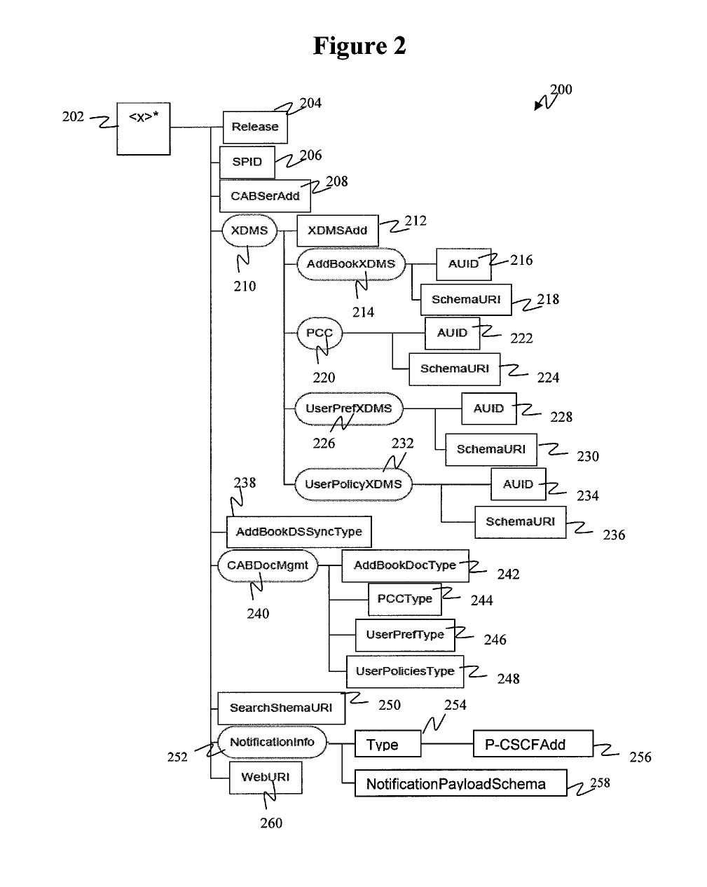

Returning to the concept of management objects, a MO is an entity that may be configured by management actions based on OMA DM protocol. A MO may be implemented as a simple data structure, such as an integer, or may be embedded or embodied in a complex data structure such as a background picture, screen saver, security certificate, data tree, or many others. The OMA DM protocol is neutral regarding the contents or values of the MOs, and treats node values as opaque data. An example of an OMA DMO is shown with respect to FIG. 2.

In a specific embodiment, the DMO 108 may have a specific utility used to provide parameters to CAB client 102. The DM client 106, which is utilized by the CAB client 102, may manage the DMO 108 on behalf of a management authority (MA). DM client 106 may communicate directly with DM server 104, possibly receiving one or more DMOs 108.

DMO 108 may have many different types and forms. Some types and/or forms of DMO 108 may be proprietary, or may be standardized. However, each type and/or form of DMO 108 may be created and used to provide specific parameters to a specific CAB client 102. For example, a CAB MO may contain parameters to provision CAB client 102 for service configuration(s) during service deployment.

In addition to the DMO 108 having many different types and forms, multiple configuration options exist to consume the CAB service. For example, CAB client 102 may use DS or XDM techniques to manage the address book data located in XDM enabler 110 and/or CAB server 112. Similarly, the CAB client 102 may choose to receive CAB-related notifications using SIP or non-SIP techniques.

However, CAB client 102 may be, in an embodiment, configured with a specific search schema in order to make search queries based on XQuery. The embodiments described herein also provide a standard solution and/or definition of specific configuration parameters to remotely manage CAB client 102 based on OMA DM protocols.

In an embodiment, a DMO 108 may include parameters such that CAB client 102 may be configured remotely based on OMA DM specifications or procedures. These parameters may be classified conveniently as a first type of parameters and a second type of parameters. However, the terms “first” and “second” are used for convenience only and are not intended to convey any order, priority/importance or meaning beyond the nature of the parameter or parameters actually specified. Thus, in differing embodiments, a “first type” of parameter might be considered a “second type,” and a “second type” of parameter might be considered a “first type.” Either the first type of parameter or the second type of parameter may, but need not, be considered a “basic parameter” or an “advanced parameter.” Any of the following parameters may be implemented as data, metadata, and/or data structures that compose or are a part of a DMO 108. Although the following parameters are described one at a time, two or more parameters, or elements thereof, may be combined into a single DMO 108. Thus, for example, an entire DMO 108 may be transmitted to a CAB client CAB client 102. Alternatively, only parameters relating to a DMO 108 may be transmitted to the CAB client 102, in which case those parameters are incorporated by the CAB client 102 into the DMO 108 that is already residing in the CAB client 102.

An example of a first type of parameter is the CAB release version. This parameter indicates the CAB release information supported by CAB client 102. Another example of a first type of parameter is the service provider identification (ID). The service provider ID indicates the identity of the service provider that is hosting the CAB service. Still another example of a first type of parameter is a CAB server access address. This parameter provides the address of the CAB server 112, which may be used in some embodiments for consuming a CAB service.

Yet another first type of parameter may be XDMS properties. This parameter provides the required or desired properties to configure the access to various CAB XDMSs, such as XDMSs 114, 116, 118, and 120. XDMS properties may include one or more of the following properties. The following examples of XDMS properties are non-exhaustive; other XDMS properties may be defined and communicated via a DMO 108.

One XDMS property may be the XDM server access address. This property may provide the XDM server address used for consuming the CAB service. If the XDM server is physically implemented along with the CAB server 112, this address may be the same as the CAB server access address.

Another XDMS property may reflect the information associated with AB XDMS 114. This property may provide the application usage identification (AUID) of the address book XDMS and the URI to obtain the XML schema of the address book XML document stored in the XDMS. The XML schema may be used for performing XDMS operations, such as XCAP, SIP subscribe/notify, search, and history management.

Still another XDMS property may reflect the information associated with PCC XDMS 116. This property may provide the AUID of the PCC XDMS and the URI usable to obtain the XML schema of the PCC XML document stored in the XDMS.

Yet another XDMS property may reflect the information associated with CAB user preferences XDMS 118. This property may provide the AUID of the User Preferences XDMS 118 and the URI usable to obtain the XML schema of the user preferences XML document stored in the XDMS.

An additional XDMS property may reflect the information associated with CAB User Policy XDMS 120. access policy. This property may provide the AUID of the User Access Policy XDMS 120 and the URI usable to obtain the XML schema of the User Preferences XML document stored in the XDMS.

In addition to the above-described first type of parameters, various embodiments may employ a variety of parameters of a second type. An example of a second type of parameter may be a CAB AB synchronization type. This node and/or attribute may be used to indicate a type of data synchronization (DS) to be supported by the CAB client 102 in order to synchronize the CAB data changes from the CAB client 102 with the network repository (which may be one or both of CAB server 112 and XDM enabler 110). Several different types of synchronization that may be supported include those based on OMA DS, such as but not limited to two-way synchronization, slow synchronization, one-way synchronization (from the client only), refresh synchronization (from the client only), one way synchronization (from the server only), refresh synchronization (from the server only), and server alerted synchronization.

Another example of a second type of parameter may be a management parameter for management of CAB XML documents stored in the XDM Enabler 110. This node and/or attribute may indicate the technology (such as but not limited to DS or XDM) that will be used to support the management of each of the CAB XML documents from the CAB client 102. Management includes operations such as add, delete, create, update, modify, and others. The CAB XML document types include documents such as AB, PCC, CAB User Preferences, and CAB User Access Policy XML documents. This parameter allows the service provider to customize the underlying technology used for the management of CAB XML documents on a per-document basis from the CAB client 102. Thus, this parameter may reflect different techniques for accessing and managing the CAB XML data.

Still another example of a second type of parameter may be a search schema URI. This node and/or attribute provides the URI usable to obtain the search schema that will be used for making search requests based on XQuery for External Directories. The search schema will allow the CAB client 102 to formulate a search request towards external directories, such as but not limited to commercial and/or third party directories. The schema of the XML format used to perform searching towards external directories may change in the network over time, and thus should be configured appropriately at the CAB client 102 in order for the CAB Client to make the appropriate search requests. The search schema for external directories may be hosted by the CAB internetworking function in the CAB server 112. In alternative embodiments, the search schema may be hosted by the search proxy, in which case the same schema may be used for both external directories and for CAB internal documents stored in the XDM Enabler 110. This latter approach promotes providing a single search request able to search both CAB and non-CAB data sources.

Yet another example of a second type of parameter may be notification information. This parameter may include the notification information to be configured in the CAB client. The notification type may be either SIP or non-SIP, such as but not limited to WAP push, SIP Push, SMS, Email, MMS, and others. For non-SIP notifications, specific notification information may be included based on the notification type. Such notification information may be used by the CAB client 102 to receive push notifications. For example, in the case of SIP, the CAB client 102 may be configured with the P-CSCF address to which the CAB client 102 registers in order to receive the notifications.

The notification information may also include a notification payload schema or a URI to obtain the schema. The notification payload schema may be used to understand and/or interpret the format of notifications received at the CAB Client. The format of the notifications may be important for the CAB Client, as there could be several cases for which notifications could be delivered to the CAB Client. For example, a notification may be sent to the CAB Client to indicate that a CAB Client should synchronize with the CAB Server using OMA DS. In another example, a notification could be sent to the CAB Client to indicate that another user has added the CAB User to his/her address book. Still in another example, a notification may be sent to the CAB Client to approve specific actions for which the CAB User's approval is required or desired. This list of examples is not exhaustive, and there could be several cases of such notification. Therefore, a notification schema may be used by a CAB client to understand these various forms of notifications.

An additional example of a second type of parameter may be a CAB web access URI. This node and/or attribute may provide a URI to access CAB services from a web portal. By providing this URI, the CAB client will be able to access the CAB services through a pre-configured web portal through an on-device web application, such as a web browser or a web-based widget application.

The above-described first and second types of parameters do not compose an exhaustive list of parameters. Other parameters may also be communicated via a DMO 108. In addition, the techniques described above may be varied and adapted for different situations. For example, in an embodiment in which a user operates multiple devices but a single CAB, an operator can configure different MSs belonging to the user differently using different DMOs. More specifically, the operator may configure a first user device in a first manner using a first DMO, but may then configure a second user device belonging to the same user using the same CAB in a second manner using a second DMO. The configurations of the first and second devices may be different by using the first and second DMOs. In another example, the embodiments may be adapted for use with DM protocols other than CAB.

The parameters described above may be provisioned to a CAB client 102 using a variety of techniques. DMO 108 might be pre-configured with default values on the CAB client 102 during the manufacture or prior to sale of the CAB client 102. Still further, DMO 108 might be dynamically configured and updated over time using OMA DM protocols and/or other techniques described above.

FIG. 2 is a block diagram illustrating an exemplary CAB management object, according to an embodiment of the disclosure. CAB management object 200 may be an example of DMO 108 of FIG. 1; however, DMO 108 of FIG. 1 may take forms different than CAB management object 200 of FIG. 2. CAB management object 200 is offered as an example of a DM object only; the various aspects and details shown in FIG. 2 may be varied as desired or required for a particular implementation. Thus, other arrangements of a CAB management object may not include all the nodes, may include additional nodes, or may include different nodes, relative to those shown in FIG. 2.

CAB management object 200 is expressed as a tree. CAB management object 200 includes a root 202, which is a node that specifies the unique object ID of a CAB MO. In an embodiment, root 202 is an interior node of a larger tree. The purpose of this interior node is to group together the parameters of a single CAB MO. The ancestor elements of this node define the position of the management tree of the CAB MO. Management Object Identifier for the CAB MO may be, for example, “urn:oma:mo:oma-cabmo:1.0”. Root 202 may have the following properties: Status: Required; Occurrence: ZeroOrMore; Format: Node; Min. Access: Get.

Release 204 is an interior node that specifies the version of the CAB release. Release 204 may have the following properties: Status: Required; Occurrence: One; Format: chr; Min. Access: Get.

SPID 206 is an interior node that specifies the service provider ID. SPID 206 may have the following properties: Status: Required; Occurrence: One; Format: chr; Min. Access: Get.

CABSerAdd 208 is an interior node that specifies the CAB server access address. CABSerAdd 208 may have the following properties: Status: Required; Occurrence: One; Format: chr; Min. Access: Get.

XDMS 210 is an interior node that is the parent node for the XDM server properties. XDMS 210 may have the following properties: Status: Required; Occurrence: ZeroOrMore; Format: chr; Min. Access: Get.

XDMS/XDMSAdd 212 is a leaf node that specifies the XDM server access address. XDMS/XDMSAdd 212 may have the following properties: Status: Required; Occurrence: One; Format: chr; Min. Access: Get.

XDMS/AddBookXDMS 214 is a leaf node that is the parent node for the address book XDM server properties. XDMS/AddBookXDMS 214 may have the following properties: Status: Required; Occurrence: One; Format: node; Min. Access: Get.

XDMS/AddBookXDMS/AUID 216 is a leaf node that specifies the application usage ID of the address book XDM server. XDMS/AddBookXDMS/AUID 216 may have the following properties: Status: Required; Occurrence: One; Format: chr; Min. Access: Get.

XDMS/AddBookXDMS/SchemaURI 218 is a leaf node that specifies the URI to obtain the XML schema of the address book XML document stored in the XDM server. XDMS/AddBookXDMS/SchemaURI 218 may have the following properties: Status: Required; Occurrence: One; Format: chr; Min. Access: Get.

XDMS/PCC 220 is a leaf node that is the parent node for the personal contact card XDM server properties. XDMS/PCC 220 may have the following properties: Status: Required; Occurrence: One; Format: node; Min. Access: Get.

XDMS/PCC/AUID 222 is a leaf node that specifies the application usage ID of the PCC XDM server. XDMS/PCC/AUID 222 may have the following properties: Status: Required; Occurrence: One; Format: chr; Min. Access: Get.

XDMS/PCC/SchemaURI 224 is a leaf node that specifies the URI to obtain the XML schema of the PCC XML document stored in the XDM server. XDMS/PCC/SchemaURI 224 may have the following properties: Status: Required; Occurrence: One; Format: chr; Min. Access: Get.

XDMS/UserPrefXDMS 226 is a leaf node that is the parent node for the user preference XDM server properties. XDMS/UserPrefXDMS 226 may have the following properties: Status: Required; Occurrence: One; Format: node; Min. Access: Get.

XDMS/UserPrefXDMS/AUID 228 is a leaf node that specifies the application usage ID of the user preferences XDM server. XDMS/UserPrefXDMS/AUID 228 may have the following properties: Status: Required; Occurrence: One; Format: chr; Min. Access: Get.

XDMS/UserPrefXDMS/SchemaURI 230 is a leaf node that specifies the URI to obtain the XML schema of the user preferences XML document stored in the XDM server. XDMS/UserPrefXDMS/SchemaURI 230 may have the following properties: Status: Required; Occurrence: One; Format: chr; Min. Access: Get.

XDMS/UserPolicyXDMS 232 is a leaf node that is the parent node for the user policy XDM server policies. XDMS/UserPolicyXDMS 232 may have the following properties: Status: Required; Occurrence: One; Format: node; Min. Access: Get.

XDMS/UserPolicy/XDMS/AUID 234 is a leaf node that specifies the application usage ID of the user policy XDM server. XDMS/UserPolicy/XDMS/AUID 234 may have the following properties: Status: Required; Occurrence: One; Format: chr; Min. Access: Get.

XDMS/UserPolicyXDMS/SchemaURI 236 is a leaf node that specifies the URI to obtain the XML schema of the user policy XML document stored in the XDM server. XDMS/UserPolicyXDMS/SchemaURI 236 may have the following properties: Status: Required; Occurrence: One; Format: chr; Min. Access: Get.

AddBookDSSynchType 238 is an interior node that specifies the CAB address book synchronization type using OMA Data Synchronization. AddBookDSSynchType 238 may have the following properties: Status: Required; Occurrence: One; Format: chr; Min. Access: Get.

CABDocMgmt 240 is an interior node that is the parent node for the CAB XML document management properties. CABDocMgmt 240 may have the following properties: Status: Required; Occurrence: One; Format: node; Min. Access: Get.

CABDocMgmt/AddBookDocType 242 is a leaf node that specifies the type of technology used to support the management of the address book. CABDocMgmt/AddBookDocType 242 may have the following properties: Status: Required; Occurrence: One; Format: chr; Min. Access: Get.

CABDocMgmt/PCCType 244 is a leaf node that specifies the type of technology used to support the management of the personal contact card. CABDocMgmt/PCCType 244 may have the following properties: Status: Required; Occurrence: One; Format: chr; Min. Access: Get.

CABDocMgmt/UserPrefType 246 is a leaf node that specifies the type of technology used to support the management of the user preferences. CABDocMgmt/UserPrefType 246 may have the following properties: Status: Required; Occurrence: One; Format: chr; Min. Access: Get.

CABDocMgmt/UserPoliciesType 248 is a leaf node that specifies the type of technology used to support the management of the user policies. CABDocMgmt/UserPoliciesType 248 may have the following properties: Status: Required; Occurrence: One; Format: chr; Min. Access: Get.

SearchSchemaURI 250 is an interior node that specifies the URI to obtain the search schema used for making search requests based on XQuery for external directories. SearchSchemaURI 250 may have the following properties: Status: Required; Occurrence: One; Format: chr; Min. Access: Get.

Notificationinfo 252 is an interior node that is the parent node for the notification information. Notificationinfo 252 may include a type 254 and also a notification payload schema 258 and/or a URI to a payload schema. Notificationinfo 252 may have the following properties: Status: Required; Occurrence: One; Format: node; Min. Access: Get.

Notification/Type 254 is a leaf node that contains the notification type. Notification/Type 254 may have the following properties: Status: Required; Occurrence: One; Format: chr; Min. Access: Get.

Notification/Type/P-CSCFAdd 256 is a leaf node that contains the P-CSCF address if SIP is the notification type. Notification/Type/P-CSCFAdd 256 may have the following properties: Status: Required; Occurrence: ZeroOrOne; Format: chr; Min. Access: Get.

Notification/NotificationPayloadSchema 258 is a leaf node that contains the payload schema for a notification. Notification/NotificationPayloadSchema 258 may have the following properties: Status: Required; Occurrence: One; Format: chr; Min. Access: Get.

WebURI 260 is an interior node that specifies the CAB web access URI. WebURI 258 may have the following properties: Status: Required; Occurrence: ZeroOrOne; Format: chr; Min. Access: Get.

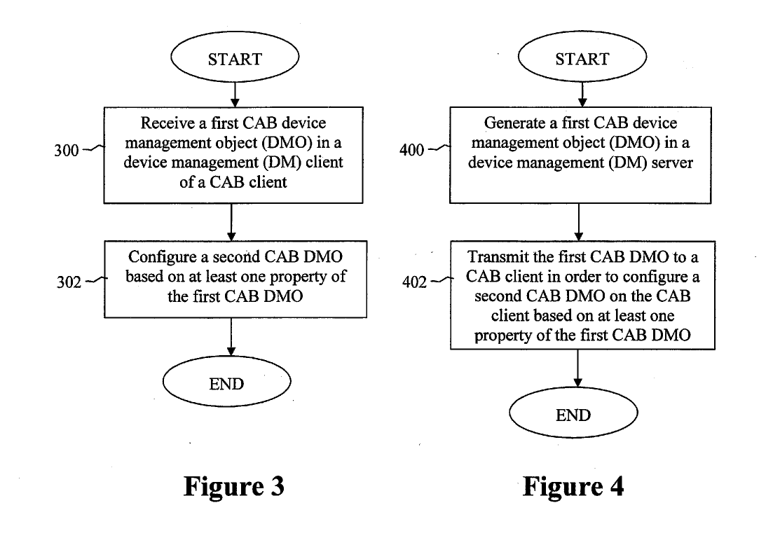

FIG. 3 is a flowchart illustrating an example process of configuring a CAB client, according to an embodiment of the disclosure. The process described in FIG. 3 may be implemented in a CAB architecture and communication system 100, such as that shown in FIG. 1. The DMOs described with respect to FIG. 3 may be any of those described with respect to FIG. 1, or might be the DMO shown in FIG. 2.

The example process begins as a CAB client receives a first CAB device management object (DMO) in a device management (DM) client of the CAB client (block 300). The CAB DM client may be stored in a computer readable storage medium, which may be tangible or otherwise intransitory, accessible by the CAB client. The CAB client then configures a second CAB DMO based on at least one property of the first CAB DMO (block 302). The process terminates thereafter.

The second CAB DMO may be stored in a computer readable storage medium accessible by the CAB client. The CAB client may then be configured using, for example, at least one property of the first CAB DMO, wherein the at least one property is selected from the group consisting of: CAB release information, service provider identification, a CAB server access address, XDMS properties, CAB address book synchronization type, an indication of the technology to be used to support management of CAB XML documents from the CAB client, a search schema universal resource indicator (URI), notification information, notification payload schema, and a CAB web access URI.

In addition to the above, other embodiments may be provided with respect to the process shown in FIG. 3. In an embodiment, first CAB DMO replaces the second CAB DMO upon receipt. In a different embodiment, at least one DMO (e.g., the first or second CAB DMO) may be pre-configured for the CAB Client, such as by a user or a provider. In a still different embodiment, the second CAB DMO may be received from a DM server prior to receiving the first CAB DMO. Thus, both CAB DMOs may be received from a server. In yet another different embodiment, configuring the second CAB DMO allows the CAB client to access at least one CAB eXtensible Markup Language Document Management Server (XDMS). In an additional different embodiment, the at least one CAB XDMS may be selected from any of a CAB access book XDMS, a CAB personal contact card XDMS, a CAB user preferences XDMS, and a CAB user policy XDMS.

FIG. 4 is a flowchart illustrating a process of generation and transmission of a CAB DMO to the CAB client, according to an embodiment of the disclosure. The process described in FIG. 4 may be implemented in a CAB architecture and communication system 100, such as that shown in FIG. 1. The DMOs described with respect to FIG. 4 may be any of those described with respect to FIG. 1, or might be the DMO shown in FIG. 2.

The process begins as a DM server generates a first CAB device management object (DMO) (block 400). The DM server then transmits the first CAB DMO to a CAB client such that the CAB client can use the CAB DMO in order to, for example, configure a second CAB DMO on the CAB client based on at least one property of the first CAB DMO (block 402). The process terminates thereafter.

The DMO may include data that allows the CAB client to configure a second DMO stored in a computer readable storage medium accessible by the CAB client. The DMO may further include at least one property selected from the group consisting of: CAB release information, service provider identification, a CAB server access address, XDMS properties, CAB address book synchronization type, an indication of the technology to be used to support management of CAB XML documents from the CAB client, a search schema universal resource indicator (URI), notification information, notification payload schema, and a CAB web access URI.

The process shown in FIG. 4 may be further modified. In a different embodiment, the second CAB DMO may have been transmitted from the DM server prior to transmitting the first CAB DMO. Thus, both CAB DMOs may be been received by the server. In still different embodiment, the second CAB DMO may be configured to allow the CAB client to access at least one CAB eXtensible Markup Language Document Management Server (XDMS). In yet another different embodiment, the at least one CAB XDMS may be selected from any of a CAB access book XDMS, a CAB personal contact card XDMS, a CAB user preferences XDMS, and a CAB user policy XDMS. Regardless, the CAB DMO may be used to provide a CAB client with configuration parameters for configuring, provisioning or re-provisioning the CAB client such that a service provider may update service configurations during service deployment.

The MS, servers, and other components described above might include a processing component that is capable of executing instructions related to the actions described above. FIG. 5 illustrates an example of a system 515 that includes a processing component 510 suitable for implementing one or more embodiments disclosed herein. In addition to the processor 510 (which may be referred to as a central processor unit or CPU), the system 500 might include network connectivity devices 520, random access memory (RAM) 530, read only memory (ROM) 540, secondary storage 550, and input/output (I/O) devices 560. These components might communicate with one another via a bus 570. In some cases, some of these components may not be present or may be combined in various combinations with one another or with other components not shown. These components might be located in a single physical entity or in more than one physical entity. Any actions described herein as being taken by the processor 510 might be taken by the processor 510 alone or by the processor 510 in conjunction with one or more components shown or not shown in the drawing, such as a digital signal processor (DSP) 590. Although the DSP 590 is shown as a separate component, the DSP 590 might be incorporated into the processor 510.

The processor 510 executes instructions, codes, computer programs, or scripts that it might access from the network connectivity devices 520, RAM 530, ROM 540, or secondary storage 550 (which might include various disk-based systems such as hard disk, floppy disk, or optical disk). While only one CPU 510 is shown, multiple processors may be present. Thus, while instructions may be discussed as being executed by a processor, the instructions may be executed simultaneously, serially, or otherwise by one or multiple processors. The processor 510 may be implemented as one or more CPU chips.

The network connectivity devices 520 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 520 may enable the processor 510 to communicate with the Internet or one or more telecommunications networks or other networks from which the processor 510 might receive information or to which the processor 510 might output information. The network connectivity devices 520 might also include one or more transceiver components 525 capable of transmitting and/or receiving data wirelessly.

The RAM 530 might be used to store volatile data and perhaps to store instructions that are executed by the processor 510. The ROM 540 is a non-volatile memory device that typically has a smaller memory capacity than the memory capacity of the secondary storage 550. ROM 540 might be used to store instructions and perhaps data that are read during execution of the instructions. Access to both RAM 530 and ROM 540 is typically faster than to secondary storage 550. The secondary storage 550 is typically comprised of one or more disk drives or tape drives and might be used for non-volatile storage of data or as an over-flow data storage device if RAM 530 is not large enough to hold all working data. Secondary storage 550 may be used to store programs that are loaded into RAM 530 when such programs are selected for execution.

The I/O devices 560 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 525 might be considered to be a component of the I/O devices 560 instead of or in addition to being a component of the network connectivity devices 520.

As described elsewhere herein, the embodiments provide for a computer readable storage medium storing a data structure comprising a converged address book (CAB) management object (MO). The computer readable storage medium may be a tangible or intransitory medium such as optical (e.g., CD, DVD, etc.), magnetic (e.g., tape) or other memory known in the art. The CAB MO includes data that allows a CAB client to be configured to use a CAB service. The CAB MO further comprises at least one property selected from the group consisting of: CAB release information, service provider identification, a CAB server access address, XDMS properties, CAB address book synchronization type, an indication of the technology to be used to support management of CAB XML documents from the CAB client, a search schema universal resource indicator (URI), notification information, notification payload schema, and a CAB web access URI.

The embodiments further provide for a method for configuring a converged address book (CAB) client on a device comprising at least a processor. A first CAB device management object (DMO) is received in a device management (DM) client stored in a computer readable storage medium accessible by the CAB client. A second CAB DMO stored in a computer readable storage medium accessible by the CAB client is configured. Configuring is based on at least one property of the first CAB DMO. The at least one property is selected from the group consisting of: CAB release information, service provider identification, a CAB server access address, XDMS properties, CAB address book synchronization type, an indication of the technology to be used to support management of CAB XML documents from the CAB client, a search schema universal resource indicator (URI), notification information, notification payload schema, and a CAB web access URI.

The embodiments yet further provide for a method for configuring a converged address book (CAB) client. A first device management object (DMO) is generated at a device management (DM) server. The DMO comprises data that allows the CAB client to configure a second DMO stored in a computer readable storage medium accessible by the CAB client. The DMO further comprises at least one property selected from the group consisting of: CAB release information, service provider identification, a CAB server access address, XDMS properties, CAB address book synchronization type, an indication of the technology to be used to support management of CAB XML documents from the CAB client, a search schema universal resource indicator (URI), notification information, notification payload schema, and a CAB web access URI. The first DMO is transmitted to the CAB client.

The embodiments may be stored in a computer readable storage medium, which may take a variety of different forms such as but not limited to hard drives, CD ROMs, DVDs, floppy disks, memory sticks, and other forms of tangible media. The embodiments may also be embodied in carrier waves. Data stored on the computer readable storage medium may be executed or accessed by a processor to accomplish the techniques described herein.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method comprising:
using a Converged Address Book (CAB) management object (MO) to configure a CAB client, the CAB MO including a parameter specifying a version of CAB Release information supported by the CAB Client.

2. The method of claim 1 further comprising:
before the using, receiving the CAB MO from a DM server.

3. The method of claim 1 wherein the CAB MO is used for initial provisioning of the parameter specifying the version of CAB Release information supported by the CAB Client.

4. The method of claim 1 wherein the CAB MO is used for continuous provisioning, thereby allowing a service provider to update the parameter specifying the version of CAB Release information supported by the CAB Client for a service configuration.

5. A method comprising:
using a Converged Address Book (CAB) management object (MO) to configure a CAB client, the CAB MO including a parameter specifying an identifier of a service provider hosting a CAB service for the CAB Client.

6. The method of claim 5 further comprising:
before the using, receiving the CAB MO from a DM server.

7. The method of claim 5 wherein the CAB MO is used for initial provisioning of the parameter specifying an identifier of a service provider hosting a CAB service for the CAB Client.

8. The method of claim 5 wherein the CAB MO is used for continuous provisioning, thereby allowing the service provider to update the parameter specifying the identifier of the service provider hosting the CAB service for the CAB Client.

9. A method comprising:
using a Converged Address Book (CAB) management object (MO) to configure a CAB client, the CAB MO including a parameter specifying an address of a CAB Server for the CAB Client.

10. The method of claim 9 further comprising:
before the using, receiving the CAB MO from a DM server.

11. The method of claim 9 wherein the CAB MO is used for initial provisioning of the parameter specifying the address of the CAB Server for the CAB Client.

12. The method of claim 9 wherein the CAB MO is used for continuous provisioning, thereby allowing a service provider to update the parameter specifying the address of the CAB Server for the CAB Client.

13. A method comprising:
using a Converged Address Book (CAB) management object (MO) to configure a CAB client, the CAB MO including a parameter specifying XDMS properties for the CAB Client.

14. The method of claim 13 further comprising:
before the using, receiving the CAB MO from a DM server.

15. The method of claim 13 wherein the CAB MO is used for initial provisioning of the parameter specifying the XDMS properties for the CAB Client.

16. The method of claim 13 wherein the CAB MO for continuous provisioning, thereby allowing a service provider to update the parameter specifying the XDMS properties for the CAB Client.
